(19) United States
(12) Patent Application Publication
(10) Pub. No.: US 2026/0160313 A1
(43) Pub. Date: Jun. 11, 2026

(54) DYNAMIC DAMPER

(71) Applicants: Sumitomo Riko Company Limited, Komaki-shi (JP); TOYOTA JIDOSHA KABUSHIKI KAISHA, Toyota-shi (JP)

(72) Inventors: Hodaka SUGIYAMA, Komaki-shi (JP); Tatsunori TANIGUCHI, Komaki-shi (JP); Tadayoshi HOSHINO, Oota-shi (JP)

(73) Assignees: Sumitomo Riko Company Limited, Komaki-shi (JP); TOYOTA JIDOSHA KABUSHIKI KAISHA, Toyota-shi (JP)

(21) Appl. No.: 19/368,019

(22) Filed: Oct. 24, 2025

(30) Foreign Application Priority Data
Dec. 10, 2024 (JP) 2024-215174

(51) Int. Cl. F16F 13/26; F16F 1/38

(52) U.S. Cl. CPC F16F 13/26; F16F 1/38; F16F 2238/04

(57) ABSTRACT

A dynamic damper to be mounted onto a tubular member mount including an inner shaft member and an outer tube member connected by an elastic body. The dynamic damper includes: an attachment fitting including a tubular circumferential wall and arranged on one axial end side of the inner shaft member to be fixed thereto with the circumferential wall extending in a center axis direction; an annular mass body spaced radially outward from the circumferential wall; and a connecting rubber elastic body connecting the circumferential wall and the mass body in an axis-perpendicular direction. A covering rubber is integrally formed with the connecting rubber elastic body and holds so as to cover a radially inner portion of the mass body from axially opposite sides. An axial dimension of the connecting rubber elastic body is smaller than that of the circumferential wall.

### INCORPORATED BY REFERENCE

The disclosure of Japanese Patent Application No. 2024-215174 filed on Dec. 10, 2024 including the specification, drawings and abstract is incorporated herein by reference in its entirety.

### BACKGROUND ART

### 1. Technical Field

The present disclosure relates to a dynamic damper to be mounted onto a member mount that supports a suspension member of a vehicle in a vibration damping manner.

### 2. Description of the Related Art

Conventionally, a member mount equipped with a dynamic damper has been discussed for the purpose of improving vibration damping support performance of a suspension member and the like. For example, it is conceivable to adopt a dynamic damper as disclosed in Japanese Unexamined Patent Publication No. JP-A-2023-054685.

### SUMMARY

However, the dynamic damper having the conventional structure as disclosed in JP-A-2023-054685 is comparatively large in size. Especially in recent vehicles where the mounting space is limited, there is still room for improvement in order to achieve downsizing while reliably obtaining vibration damping performance.

Besides, in such a conventional dynamic damper, a mass body becomes longer in the vertical direction in order to surely obtain an area for the mass body to be fixed by press-fitting to a press-fit sleeve (a cylinder part). In addition, it is difficult to stably support the mass body by an elastic connection body located at the lower end. This makes it difficult to ensure durability of the elastic connection body, and it is also difficult to avoid an adverse effect on the vibration damping performance due to a large swing of the mass body.

It is therefore one object of the present disclosure to provide a dynamic damper of novel structure which is able to reliably obtain the vibration damping performance with a compact structure, and to improve the durability and the vibration damping support performance of the suspension member, and the like.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a dynamic damper configured to be mounted onto a tubular member mount, the tubular member mount including an inner shaft member and an outer tube member connected by an elastic body, the dynamic damper comprising: an attachment fitting including a tubular circumferential wall, the attachment fitting being arranged on one axial end side of the inner shaft member of the tubular member mount and fixed to the inner shaft member with the tubular circumferential wall extending in a center axis direction; an annular mass body spaced radially outward from the tubular circumferential wall of the attachment fitting; and a connecting rubber elastic body connecting opposed surfaces of the tubular circumferential wall and the annular mass body in an axis-perpendicular direction, wherein a covering rubber is integrally formed with a radially outer portion of the connecting rubber elastic body, the covering rubber spreading over axially opposite end surfaces of the annular mass body and holding to cover a radially inner portion of the annular mass body from axially opposite sides, and an axial dimension of the connecting rubber elastic body is smaller than that of the tubular circumferential wall.

According to the dynamic damper structured following the present preferred embodiment, the mass body is directly fastened to the connecting rubber elastic body. Thus, a press-fit sleeve and a press-fit process in the conventional structure can be obviated, thereby simplifying the structure and reducing the size.

Besides, the covering rubber is provided to cover the radially inner portion of the mass body from the axially opposite sides, and the radially inner portion of the mass body is embedded in the connecting rubber elastic body and the covering rubber integrally formed with each other. This makes it possible to reliably obtain a fastening area and fastening strength of the mass body with respect to the connecting rubber elastic body and the covering rubber. Moreover, the center of gravity of the mass body and the elastic center of the connecting rubber elastic body can be brought closer to each other in the axial direction, thereby stable support of the mass body can be realized. This stabilizes displacement of the mass body during vibration input and achieves improvement in vibration damping performance.

Additionally, in the portion where the mass body is fastened to the connecting rubber elastic body, the covering rubber is provided on the axially opposite sides. Thus, even if the position of the mass body deviates slightly in the axial direction during molding of the connecting rubber elastic body, the fastening area of the connecting rubber elastic body and the covering rubber to the mass body is stably obtained. Thus, the desired ability can be achieved in a stable manner.

Furthermore, the axial dimension of the connecting rubber elastic body is smaller than that of the circumferential wall. This efficiently provides space that allows elastic deformation of the connecting rubber elastic body and displacement of the mass body in the radially outer area of the circumferential wall. This makes it easy to avoid interference with other components arranged around the dynamic damper.

A second preferred embodiment provides the dynamic damper according to the first preferred embodiment, wherein axially opposite end surfaces of the connecting rubber elastic body between the opposed surfaces of the tubular circumferential wall and the annular mass body in the axis-perpendicular direction are located outside in an axial direction with respect to the axially opposite end surfaces of the radially inner portion of the annular mass body, and axially opposite side portions of the connecting rubber elastic body extend radially outward to integrally form the covering rubber.

According to the dynamic damper structured following the present preferred embodiment, it is possible to effectively obtain the fastening area and the fastening strength of the mass body to the connecting rubber elastic body by the covering rubber in a reliable manner, improve the vibration damping performance by stabilizing the displacement of the mass body during vibration input, avoid interference with other components by reliably obtaining space, and the like. In addition, it is also possible to efficiently obtain elastic characteristics of the connecting rubber elastic body including the covering rubber in a limited and narrow space, as well as to improve the durability of the connecting rubber elastic body including the covering rubber.

A third preferred embodiment provides the dynamic damper according to the first or second preferred embodiment, wherein the radially inner portion of the annular mass body includes a thick-walled part whose axial dimension is larger than that of a radially outer portion of the annular mass body.

According to the dynamic damper structured following the present preferred embodiment, the mass of the mass body is distributed larger on the radially inner side, which is the side closer to the support position by the connecting rubber elastic body, than on the radially outer side. Thus, stabilization in displacement of the mass body during vibration input can be achieved, thereby improving the vibration damping performance.

A fourth preferred embodiment provides the dynamic damper according to the third preferred embodiment, wherein on an axial end surface of the annular mass body, the covering rubber spreads as far as a radially outer side of the thick-walled part and covers a radially outer end of the thick-walled part.

According to the dynamic damper structured following the present preferred embodiment, the thick-walled part of the mass body with a larger mass is covered and supported by the connecting rubber elastic body and the covering rubber spreading as far as the radially outer side. Thus, the displacement of the mass body during vibration input is more stable, thereby further improving the vibration damping performance.

A fifth preferred embodiment provides the dynamic damper according to any one of the first through fourth preferred embodiments, wherein the attachment fitting and the annular mass body are bonded by vulcanization to the connecting rubber elastic body.

According to the dynamic damper structured following the present preferred embodiment, by the attachment fitting and the mass body being bonded by vulcanization during vulcanization molding of the connecting rubber elastic body, the bonding process can be omitted and high bonding strength can be easily obtained.

A sixth preferred embodiment provides the dynamic damper according to any one of the first through fifth preferred embodiments, wherein a radially outer end portion of the covering rubber includes a material casting trace during molding of the connecting rubber elastic body.

According to the dynamic damper structured following the present preferred embodiment, the material casting trace is unlikely to affect the characteristics of the connecting rubber elastic body provided on the radially inner side of the covering rubber, so that the performance of the connecting rubber elastic body, which is likely to affect the mass-spring system, is stabilized. This enables the vibration damping performance to be efficiently exerted during vibration input.

A seventh preferred embodiment provides the dynamic damper according to any one of the first through sixth preferred embodiments, wherein the attachment fitting includes a flange-shaped protrusion spreading radially outward from an axial end of the tubular circumferential wall, the axial end being located on an axially opposite side to the tubular member mount, and a radially outer end of the flange-shaped protrusion is located on a radially outer side of a radially inner end of the annular mass body to constitute a fail-safe structure that prevents detachment of the annular mass body due to a break of the connecting rubber elastic body.

According to the dynamic damper structured following the present preferred embodiment, even if the connecting rubber elastic body breaks, the mass body will be caught by the flange-shaped protrusion of the attachment fitting, thereby preventing troubles such as the mass body detaching to fall to the road surface and the like.

An eighth preferred embodiment provides the dynamic damper according to any one of the first through seventh preferred embodiments, wherein the tubular circumferential wall includes a tapered part on an other axial end located on a side of the tubular member mount, the tapered part gradually decreasing in diameter outward in an axial direction, and the connecting rubber elastic body is fastened to an outer circumferential surface of the tapered part as well.

According to the dynamic damper structured following the present preferred embodiment, the circumferential wall of the attachment fitting decreases in diameter in the tapered part, which makes it easier to avoid interference with other components around. Besides, the connecting rubber elastic body is fastened as far as the outer circumferential surface of the tapered part, which makes it easier to obtain the fastening area of the connecting rubber elastic body to the attachment fitting more largely.

A ninth preferred embodiment provides the dynamic damper according to any one of the first through eighth preferred embodiments, wherein the attachment fitting includes a base wall having a flat plate shape and spreading radially inward from an other axial end of the tubular circumferential wall, the other axial end being located on a side of the tubular member mount, and a radially outer portion of the base wall includes an annular stepped part, and a radially inner side of the annular stepped part comprises an attachment surface protruding in an axial direction.

According to the dynamic damper structured following the present preferred embodiment, the range of fastening of the connecting rubber elastic body to the base wall of the attachment fitting is defined by the stepped part provided in the base wall of the attachment fitting. This makes it possible to prevent burrs of the connecting rubber elastic body from extending out to the attachment surface on the radially inner side of the stepped part.

A tenth preferred embodiment provides the dynamic damper according to the ninth preferred embodiment configured to be mounted onto the tubular member mount including a brace fitting spreading in the axis-perpendicular direction at one axial end of the inner shaft member, the brace fitting including: an annular rising piece formed at a radially outer edge of the brace fitting, the annular rising piece being located on a radially outer side with respect to the covering rubber of the connecting rubber elastic body while extending in the axial direction toward the annular mass body; and an annular concave stepped part provided in a radially middle portion of an axially outer surface of the brace fitting such that a radially inner side of the annular concave stepped part comprises an attachment target surface recessed in the axial direction, wherein the attachment surface of the attachment fitting is overlapped with the attachment target surface such that the annular stepped part of the attachment fitting is aligned with the annular concave stepped part in the axis-perpendicular direction.

According to the dynamic damper structured following the present preferred embodiment, the attachment fitting and the brace fitting can be aligned in the axis-perpendicular direction by the stepped part and the concave stepped part. Since extension of the connecting rubber elastic body to the attachment surface of the attachment fitting is avoided by the stepped part, the rubber is prevented from being interposed between the overlapped surfaces of the attachment surface of the attachment fitting and the attachment target surface of the brace fitting, thereby securely fixing the attachment fitting and the brace fitting.

According to the present disclosure, the dynamic damper to be mounted onto the member mount is able to reliably obtain the vibration damping performance with a compact structure, and to improve the durability and the vibration damping support performance of the suspension member, and the like.

### BRIEF DESCRIPTION OF THE DRAWINGS

The foregoing and/or other objects, features and advantages of the disclosure will become more apparent from the following description of a practical embodiment with reference to the accompanying drawings in which like reference numerals designate like elements and wherein:

FIG. 1 is a vertical cross-sectional view of a dynamic damper according to a first practical embodiment of the present disclosure in a mounted state to a member mount;

FIG. 2 is a top plan view of an attachment fitting of the dynamic damper shown in FIG. 1;

FIG. 3 is a bottom plan view of the attachment fitting shown in FIG. 2;

FIG. 4 is a top plan view of a mass member of the dynamic damper shown in FIG. 1; and

FIG. 5 is a bottom plan view of the mass member shown in FIG. 4.

### DETAILED DESCRIPTION

Hereinafter, a practical embodiment of the present disclosure will be described in reference to the drawings.

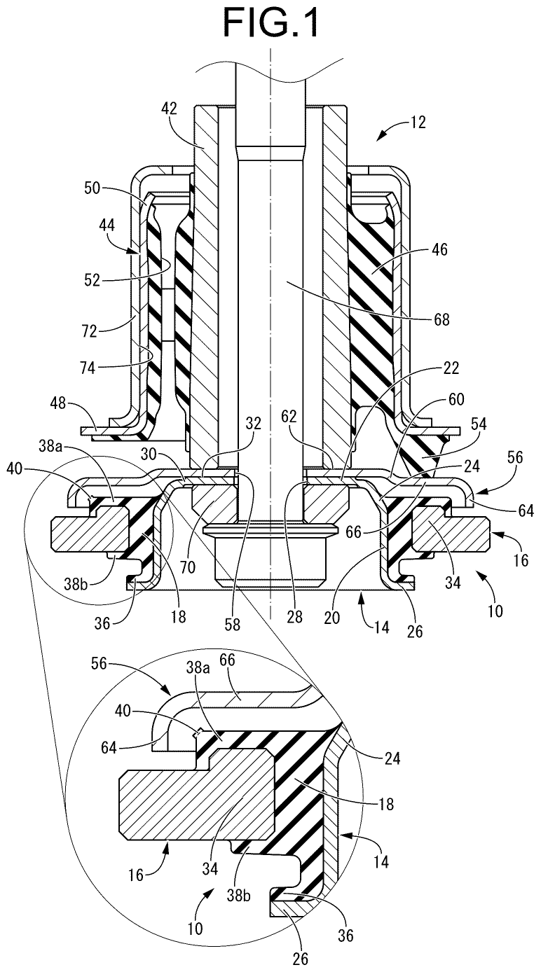

FIG. 1 shows a dynamic damper 10 according to a first practical embodiment of the present disclosure in an attached state to a member mount 12. The dynamic damper 10 has a structure in which an attachment fitting 14 and a mass member 16 serving as a mass body are connected by a connecting rubber elastic body 18. In the following description, as a general rule, the vertical direction refers to the vertical direction in FIG. 1, which is the axial direction.

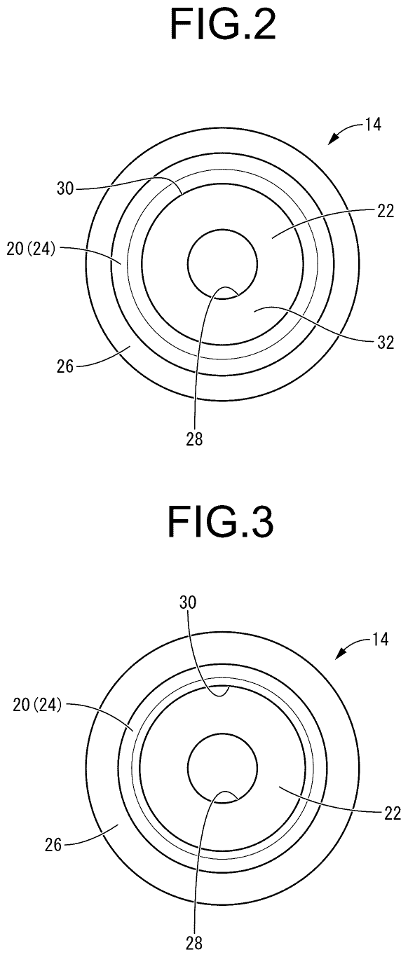

As shown in FIG. 1 to 3, the attachment fitting 14 has an inverted cylindrical shape with a bottom overall, and is formed of metal such as iron and aluminum alloy. The attachment fitting 14 has a structure in which a base wall 22 protrudes radially inward from the upper end of a circumferential wall 20 of approximately cylindrical shape.

The upper end of the circumferential wall 20 of the attachment fitting 14 comprises a tapered part 24 that gradually decreases in diameter upward. The tapered part 24 may vary in inclination angle in the vertical direction, but in the present practical embodiment, the tapered part 24 is constricted in diameter upward at an approximately constant inclination angle. Besides, the lower end of the circumferential wall 20 of the attachment fitting 14 is provided with a flange-shaped protrusion 26 spreading radially outward. The flange-shaped protrusion 26 in the present practical embodiment is formed by bending the lower end of the circumferential wall 20 radially outward, so that the lower end of the circumferential wall 20 is expanded downward. The vertically middle portion of the circumferential wall 20 has a straight cylindrical shape that extends approximately parallel to the vertical direction.

The base wall 22 of the attachment fitting 14 has a generally annular disk shape that spreads approximately orthogonally to the vertical direction, and is penetrated by a bolt insertion hole 28 at the center portion in the vertical direction. The base wall 22 includes an annular stepped part 30 in the radially outer portion, and the radially inner side of the stepped part 30 comprises an attachment surface 32 protruding upward with respect to the radially outer side thereof. The attachment surface 32 is a flat surface whose upper and lower surfaces spread orthogonally to the vertical direction.

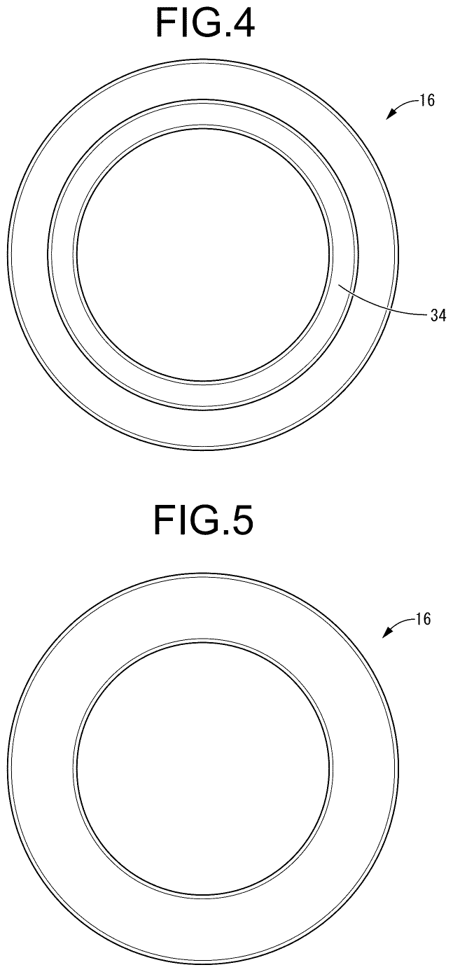

As shown in FIGS. 1, 4, and 5, the mass member 16 has a generally annular shape overall, and extends annularly in continuous fashion with an approximately constant cross-sectional shape. The mass member 16 is preferably made of a metallic material of high specific gravity such as iron, for example. The inside diameter dimension of the mass member 16 is larger than the outside diameter dimension of the vertically middle portion of the circumferential wall 20 of the attachment fitting 14. Besides, the inside diameter dimension of the mass member 16 is preferably smaller than the outside diameter dimension of the flange-shaped protrusion 26 of the attachment fitting 14. The radially outer end of the flange-shaped protrusion 26 is preferably located on the radially outer side of the radially inner end of the mass member 16 to constitute a fail-safe structure described later.

The radially inner portion of the mass member 16 includes a thick-walled part 34 whose vertical dimension (thickness dimension) is larger than that of the radially outer portion of the mass member 16. Regarding the thick-walled part 34, its lower surface comprises a common plane with the radially outer portion, while its upper surface protrudes further upward than the upper surface of the radially outer portion. That is, the thick-walled part 34 is made thick so as to protrude upward with respect to the radially outer portion thereof. The radial width dimension of the thick-walled part 34 is set to avoid interference with a rising piece 64 of a brace fitting 56 described later, and in the present practical embodiment, it is not greater than half of the entire radial width dimension of the mass member 16. Besides, the upward protrusion height dimension of the thick-walled part 34 is set to avoid interference with the brace fitting 56 described later, and in the present practical embodiment, it is not greater than half of the thickness dimension of the radially outer portion of the mass member 16.

The mass member 16 is placed externally about the circumferential wall 20 of the attachment fitting 14 so as to be spaced radially outward from the circumferential wall 20 of the attachment fitting 14, and the circumferential wall 20 of the attachment fitting 14 and the mass member 16 are elastically connected to each other by the connecting rubber elastic body 18. The connecting rubber elastic body 18 has an annular shape overall, and is provided radially between the circumferential wall 20 of the attachment fitting 14 and the mass member 16. The attachment fitting 14 and the mass member 16 may be fastened to the connecting rubber elastic body 18 after molding by bonding, welding, or other means. However, in the present practical embodiment, they are bonded by vulcanization to the connecting rubber elastic body 18 during molding. Therefore, the connecting rubber elastic body 18 in the present practical embodiment takes the form of an integrally vulcanization molded component incorporating the attachment fitting 14 and the mass member 16. Specifically, regarding the connecting rubber elastic body 18, its inner circumferential surface is bonded by vulcanization to the circumferential wall 20 of the attachment fitting 14, while its outer circumferential surface is bonded by vulcanization to the mass member 16.

The upper end of the connecting rubber elastic body 18 reaches the tapered part 24 of the circumferential wall 20 of the attachment fitting 14, and is bonded by vulcanization to the outer circumferential surface of the tapered part 24 as well. In the circumferential wall 20 of the attachment fitting 14, the upper part of the tapered part 24, which constitutes the upper end, and the flange-shaped protrusion 26, which constitutes the lower end, protrude outward with respect to the connecting rubber elastic body 18 in the upper and lower directions respectively. Accordingly, the vertical dimension of the connecting rubber elastic body 18 is smaller than that of the circumferential wall 20. The upper surface of the flange-shaped protrusion 26 of the attachment fitting 14 is covered with a cushion rubber layer 36 integrally formed with the connecting rubber elastic body 18.

Regarding the connecting rubber elastic body 18 arranged radially between the circumferential wall 20 of the attachment fitting 14 and the mass member 16, the vertically opposite end surfaces are located oppositely outside in the axial direction with respect to the vertically opposite end surfaces of the thick-walled part 34 of the mass member 16. Accordingly, the vertical dimension of the connecting rubber elastic body 18 is larger than that of the thick-walled part 34. The connecting rubber elastic body 18 is integrally provided with covering rubbers 38a, 38b by its upper and lower opposite end portions extending radially outward. The connecting rubber elastic body 18 in the present practical embodiment is continuous in the radial direction radially between the outer circumferential surface of the circumferential wall 20 of the attachment fitting 14 and the inner circumferential surface of the mass member 16 (including the axial extension portion).

The covering rubber 38a extends radially outward from the upper end of the radially outer end of the connecting rubber elastic body 18, and spreads over the upper end surface of the thick-walled part 34 of the mass member 16, thereby covering the upper surface of the thick-walled part 34. The covering rubber 38a spreads as far as the radially outer side of the thick-walled part 34 of the mass member 16, and covers the outer circumferential surface of the thick-walled part 34. The outside diameter dimension of the covering rubber 38a is smaller than the inside diameter dimension of the rising piece 64 of the brace fitting 56 described later. The covering rubber 38b extends radially outward from the lower end of the radially outer end of the connecting rubber elastic body 18, and spreads over the lower end surface of the thick-walled part 34 of the mass member 16, thereby covering the lower end surface of the thick-walled part 34. The covering rubber 38b is spaced apart upward from the cushion rubber layer 36 covering the upper surface of the flange-shaped protrusion 26.

With the covering rubbers 38a, 38b integrally formed with the connecting rubber elastic body 18, the thick-walled part 34, which is the radially inner portion of the mass member 16, is bonded by vulcanization to the connecting rubber elastic body 18 and the covering rubbers 38a, 38b over a large area so as to be inserted therein. The radially outer portion of the mass member 16 protrudes radially outward with respect to the covering rubbers 38a, 38b. In the present practical embodiment, the covering rubber 38a, which covers the upper side of the mass member 16, extends further outward in the radial direction than the covering rubber 38b, which covers the lower side of the mass member 16. The covering rubber 38a protruding further outward includes a material casting trace 40. The material casting trace 40 is a trace of a gate for casting a rubber material into the cavity of the mold during molding of the connecting rubber elastic body 18, and is located at the radially outer end portion of the covering rubber 38a. In the present practical embodiment, the material casting trace 40 protrudes at the corner where the upper surface and the outer circumferential surface of the covering rubber 38a intersect each other.

The connecting rubber elastic body 18 is not fastened to the attachment surface 32 of the base wall 22 of the attachment fitting 14. Specifically, when molding the connecting rubber elastic body 18, the attachment fitting 14 is set in the mold. Here, the position where the connecting rubber elastic body 18 is formed, including burrs during molding, is defined by utilizing the stepped part 30 provided on the radially outer side of the attachment surface 32 of the base wall 22. Thus, the rubber material is not allowed to infiltrate on the attachment surface 32 on the radially inner side of the stepped part 30. Therefore, both the upper and lower surfaces of the attachment surface 32 are exposed without being covered by any rubber.

In the dynamic damper 10, the mass member 16 is directly fastened to the connecting rubber elastic body 18. This obviates a press-fit sleeve for attaching the mass member 16, and the press-fit process can be omitted. This makes it possible to achieve a simple and compact structure of the dynamic damper 10 or the like by reducing the number of parts.

In the present practical embodiment, the connecting rubber elastic body 18 is bonded by vulcanization to the attachment fitting 14 and the mass member 16, and the connecting rubber elastic body 18 takes the form of an integrally vulcanization molded component incorporating the attachment fitting 14 and the mass member 16. Therefore, there is no need to bond the attachment fitting 14 and the mass member 16 in a separate process after molding of the connecting rubber elastic body 18, thereby achieving ease of manufacture. Furthermore, since the attachment fitting 14 and the mass member 16 are bonded by vulcanization to the connecting rubber elastic body 18, high bonding strength can also be obtained. The connecting rubber elastic body 18, the cushion rubber layer 36, and the covering rubbers 38a, 38b are integrally molded by vulcanization.

Since the radially inner portion of the mass member 16 comprises the thick-walled part 34 with a large axial dimension, it is easy to obtain a large fastening area between the radially inner portion of the mass member 16 and the connecting rubber elastic body 18. Besides, the thick-walled part 34, which is the radially inner portion of the mass member 16, is covered from the axially opposite sides by the covering rubbers 38a, 38b, and is embedded between the covering rubbers 38a, 38b so as to be inserted therebetween. Therefore, a large fastening area between the mass member 16 and the connecting rubber elastic body 18 is ensured, thereby reliably obtaining the large fastening strength in a stable manner.

Even if the position of the mass member 16 deviates slightly in the axial direction during molding of the connecting rubber elastic body 18, the covering rubbers 38a, 38b are provided on the axially opposite sides of the mass member 16, so that the fastening area of the connecting rubber elastic body 18 and the covering rubbers 38a, 38b to the mass member 16 is stably obtained. Thus, the desired ability such as fastening strength can be achieved in a stable manner.

The connecting rubber elastic body 18 fastened to the circumferential wall 20 of the attachment fitting 14 is fastened as far as the outer circumferential surface of the tapered part 24 of the circumferential wall 20. This makes it possible to ensure the fastening area of the connecting rubber elastic body 18 to the attachment fitting 14 more largely, thereby obtaining the fastening strength more stably and largely.

The dynamic damper 10 of the above construction is attached to the member mount 12, as shown in FIG. 1. The member mount 12 is a tubular vibration-damping device having a structure in which an inner shaft member 42 and an outer tube member 44 are connected by an elastic body 46.

The inner shaft member 42 has a thick-walled, small-diameter, cylindrical shape, and extends straight in the vertical direction. The center hole of the inner shaft member 42 has a diameter larger than that of the bolt insertion hole 28 formed in the attachment fitting 14 of the dynamic damper 10. The outside diameter dimension of the lower end surface of the inner shaft member 42 is preferably not greater than that of the attachment surface 32 of the base wall 22 of the attachment fitting 14.

The outer tube member 44 has a thin-walled, large-diameter, approximately cylindrical shape, and includes a flange part 48 integrally formed at its lower end. The flange part 48 has an annular disk shape and protrudes radially outward. The minimum inside diameter dimension of the outer tube member 44 is larger than the outside diameter dimension of the inner shaft member 42. The upper end of the outer tube member 44 comprises a constricted part 50 that decreases in diameter upward.

With the inner shaft member 42 inserted in the outer tube member 44, the elastic body 46 is provided radially between the inner shaft member 42 and the outer tube member 44. The elastic body 46 has an approximately cylindrical shape overall, and its inner circumferential surface is bonded by vulcanization to the outer circumferential surface of the inner shaft member 42, while its outer circumferential surface is bonded by vulcanization to the inner circumferential surface of the outer tube member 44. The elastic body 46 may have a constant cross-sectional shape over the entire circumference. However, in the present practical embodiment, there are provided through holes 52 on the opposite sides along an axis in the diametrical direction with the inner shaft member 42 interposed therebetween, thereby adjusting the spring ratio in the two axis-perpendicular directions. On the lower surface of the flange part 48 of the outer tube member 44, a stopper rubber 54 is integrally formed with the elastic body 46 so as to protrude downward. By performing a diameter reduction process on the outer tube member 44 after vulcanization molding of the elastic body 46, the tensile stress caused by thermal shrinkage of the elastic body 46 after molding is moderated, thereby improving durability of the elastic body 46. Besides, during the diameter reduction process on the outer tube member 44, by further reducing the diameter of the upper end of the outer tube member 44 to form a constricted part 50, the upper end of the elastic body 46 is pre-compressed in the radial direction. Accordingly, further improvement in durability of the elastic body 46 is achieved.

The brace fitting 56, which spreads approximately orthogonally to the vertical direction, is overlapped on the lower surface of the inner shaft member 42. The brace fitting 56 has an approximately annular disk shape overall, and includes a bolt insertion hole 58 formed in the diametrical center thereof. The brace fitting 56 is a highly rigid component formed of a metallic material. The brace fitting 56 has a stepped part 60 in the radially middle portion, and the radially inner side of the stepped part 60 is located above the radially outer side thereof. With this configuration, in the brace fitting 56, the radially inner side of the stepped part 60 is recessed upward, and the lower surface of the said recessed portion comprises an attachment target surface 62.

A tubular rising piece 64 protruding downward is integrally formed with the radially outer end of the brace fitting 56. The rising piece 64 increases deformation rigidity of the brace fitting 56 having the annular disk shape. The portion located radially between the stepped part 60 and the rising piece 64 in the brace fitting 56 comprises a stopper abutting part 66 that is vertically opposed to the flange part 48 of the outer tube member 44. The stopper abutting part 66 spreads approximately orthogonally to the vertical direction.

The dynamic damper 10 is attached to the member mount 12 constructed as described above. Specifically, the attachment surface 32 of the base wall 22 of the attachment fitting 14 is overlapped with the attachment target surface 62 of the brace fitting 56 from below, and the attachment fitting 14 is arranged below the inner shaft member 42 with the circumferential wall 20 extending in the center axis direction of the inner shaft member 42. The inner shaft member 42, the brace fitting 56, and the attachment fitting 14 are fixed to one another by a bolt 68 inserted through the bolt insertion hole 28 of the attachment fitting 14, the bolt insertion holes 58 of the brace fitting 56, and the center hole of the inner shaft member 42. By so doing, the attachment fitting 14 of the dynamic damper 10 is attached to the inner shaft member 42 of the member mount 12. In the present practical embodiment, a spacer 70 is interposed between the head of the bolt 68 and the base wall 22 of the attachment fitting 14.

In the attached state to the inner shaft member 42, the brace fitting 56 protrudes radially outward with respect to the inner shaft member 42, and the stopper abutting part 66 of the brace fitting 56 is opposed to the flange part 48 of the outer tube member 44 from below. The stopper rubber 54 protruding from the flange part 48 of the outer tube member 44 is in contact with the stopper abutting part 66 of the brace fitting 56 in advance, and the stopper rubber 54 is vertically compressed between the flange part 48 and the stopper abutting part 66. The brace fitting 56 may be fixed to the inner shaft member 42 by welding or other means after vulcanization molding of the elastic body 46, for example, with the upper surface of the recessed portion on the radially inner side of the stepped part 60 being overlapped with the lower end surface of the inner shaft member 42.

The base wall 22 of the attachment fitting 14 is smaller in diameter than the stepped part 60 of the brace fitting 56, and is inserted into the radial inside of the stepped part 60. Therefore, the stepped part 30 of the base wall 22 and the stepped part 60 of the brace fitting 56 align the attachment fitting 14 with the brace fitting 56 in the radial direction to some extent, which achieves ease of positioning work of the attachment fitting 14 before fixing it to the brace fitting 56 and the inner shaft member 42. In the present practical embodiment, in the brace fitting 56, the entire lower surface of the radially inner side of the stepped part 60 comprises the attachment target surface 62. However, for example, by providing a concave stepped part on the radially inner side of the brace fitting 56 to be recessed upward so that the radially inner side of the concave stepped part is located above the radially outer side thereof, the lower surface of the said recessed portion may comprise the attachment target surface. In this case, for example, it is desirable to set the inside diameter dimension of the concave stepped part of the brace fitting 56 to be the same as or slightly larger than the outside diameter dimension of the stepped part 30 provided to the base wall 22 of the attachment fitting 14 of the dynamic damper 10. This also makes it possible to align the attachment fitting 14 and the brace fitting 56 more precisely in the radial direction before fixing them by inserting the stepped part 30 of the attachment fitting 14 into the concave stepped part of the brace fitting 56 such that the attachment surface 32 of the attachment fitting 14 and the attachment target surface of the brace fitting 56 overlap each other.

The rising piece 64 of the brace fitting 56 is located on the radially outer side with respect to the covering rubber 38a and protrudes downward toward the radially outer portion of the mass member 16. The rising piece 64 is spaced apart upward from the radially outer portion of the mass member 16, which is thinner than the radially inner portion, thereby allowing displacement of the mass member 16 in the vertical direction.

With the dynamic damper 10 mounted to the member mount 12 as described above, the rising piece 64 of the brace fitting 56 is located on the radially outer side with respect to the thick-walled part 34 of the mass member 16. The rising piece 64 is located on the radially outer side with respect to the covering rubber 38a that covers the outer circumferential surface of the thick-walled part 34 of the mass member 16. The protruding distal end surface (the lower end surface) of the rising piece 64 is spaced apart upward from the upper surface of the radially outer portion of the mass member 16. The mass member 16 is made thicker in its radially inner portion than in its radially outer portion, thereby avoiding interference with the rising piece 64 while ensuring a large mass. The rising piece 64 protrudes to the position such that the rising piece 64 overlaps the covering rubber 38a, which covers the upper surface of the thick-walled part 34 of the mass member 16, as viewed in the radial direction. With this arrangement, the radially outer portion of the brace fitting 56 comprises a covering portion that covers the upper part of the thick-walled part 34 protruding upward at the radially inner portion of the mass member 16 and the covering rubber 38a covering the upper part of the thick-walled part 34, so as to be spaced apart upward and outward. This makes it possible to protect the upper part of the thick-walled part 34 and the covering rubber 38a from being struck by foreign objects from above and from the radial outside, and from heat radiation, thereby effectively preventing the covering rubber 38a and hence the connecting rubber elastic body 18 from being deteriorated or damaged.

The member mount 12 is attached to the vehicle by, for example, the inner shaft member 42 being attached to a vehicle body side (not shown) by means of the bolt 68, while the outer tube member 44 being fixed by press-fitting into a mounting hole 74 of a suspension member 72.

With the member mount 12 mounted on the vehicle, when a vertical vibration is input across the inner shaft member 42 and the outer tube member 44, a vibration damping effect due to the elastic deformation of the elastic body 46 will be exhibited.

During input of the vertical vibration, the dynamic damper 10 also exhibits a vibration damping effect. Specifically, when the vertical vibration is input across the inner shaft member 42 and the outer tube member 44, the vibration is transmitted to the attachment fitting 14 attached to the inner shaft member 42. Accordingly, the mass member 16 elastically connected to the attachment fitting 14 via the connecting rubber elastic body 18 is vibrated in the vertical direction. By so doing, vibration damping action of the dynamic damper 10 is exerted on the vehicle body (not shown) via the inner shaft member 42, thereby improving the vibration state of the vehicle body. The vibration damping action of the dynamic damper 10 is exerted during input of the target vibration to be damped by tuning the resonance frequency of the mass-spring system, in which the mass member 16 is the mass component and the connecting rubber elastic body 18 is the spring component, to the frequency of the target vibration to be damped.

By providing the covering rubbers 38a, 38b so as to cover both the upper and lower sides of the mass member 16, the center of gravity of the mass member 16 and the elastic center of the rubber elastic body, which includes the connecting rubber elastic body 18 and the covering rubbers 38a, 38b, can be brought closer to each other in the axial direction. With this configuration, stable elastic support of the mass member 16 is realized, and the displacement of the mass member 16 during vibration input is stabilized, thereby stably obtaining the desired vibration damping performance. In the present practical embodiment in particular, the axially opposite end surfaces of the connecting rubber elastic body 18 are located outside in the axial direction with respect to the axially opposite end surfaces of the thick-walled part 34, so that the axial dimension of the connecting rubber elastic body 18 is larger than that of the thick-walled part 34. The covering rubbers 38a, 38b are integrally formed so as to extend in the radial direction directly from the upper and lower end portions of the connecting rubber elastic body 18, which are located on the axially opposite outer sides with respect to the thick-walled part 34. In this way, the connecting rubber elastic body 18 is located over the entirety of the opposed surfaces of the mass member 16 (the thick-walled part 34) and the circumferential wall 20 of the attachment fitting 14, and spreads out to the axially opposite sides beyond the said opposed surfaces. Thus, stable support for the mass member 16 can be achieved, and it is possible to adjust or reliably obtain the spring characteristics of the mass member 16 by utilizing the covering rubbers 38a, 38b. In addition, the stress concentration in the connecting rubber elastic body 18 and the covering rubbers 38a, 38b is reduced, thereby improving durability.

In the present practical embodiment, since the radially inner portion of the mass member 16 comprises the thick-walled part 34, the center of gravity of the mass member 16 is set on the radially inner side supported by the connecting rubber elastic body 18. This makes the displacement of the mass member 16 more stable during vibration input, thereby further stabilizing the desired vibration damping performance. Besides, the thick-walled part 34 in the present practical embodiment is formed by protruding axially upward with respect to the radially outer portion of the mass member 16 so as to be thick-walled. Accordingly, the center of the support spring of the mass member 16 is slightly offset upward in the axial direction with respect to the center of gravity of the mass member 16. As a result, excessive interference of the mass member 16 with the brace fitting 56 due to upward displacement or the like can be suppressed.

The covering rubber 38a in the present practical embodiment spreads out so as to cover as far as the outer circumferential surface of the thick-walled part 34 of the mass member 16. With this configuration, the thick-walled part 34 of the mass member 16, which has a large mass, is elastically supported over a wide area, thereby stabilizing the vibration damping performance by stable displacement of the mass member 16 during vibration input.

The axial length of the connecting rubber elastic body 18 is shorter than that of the circumferential wall 20 of the attachment fitting 14. This efficiently provides space on the radially outer side of the circumferential wall 20 to allow elastic deformation of the connecting rubber elastic body 18 and displacement of the mass member 16, thereby making it easy to avoid interference with other components arranged around the dynamic damper 10.

Since the upper part of the circumferential wall 20 of the attachment fitting 14 comprises the tapered part 24 whose diameter decreases upward, it is easy to avoid interference between the attachment fitting 14 and other components around. In particular, the upper part of the tapered part 24 protruding upward from the connecting rubber elastic body 18 has a smaller diameter. Thus, interference between the attachment fitting 14 and other components around is less likely to be a problem.

The material casting trace 40, which is the trace of the gate for casting a rubber material during molding of the connecting rubber elastic body 18, is located at the radially outer end of the covering rubber 38a away from the connecting rubber elastic body 18 that is likely to affect the tuning and the vibration damping characteristics of the dynamic damper 10. Accordingly, the material casting trace 40 is less likely to affect the vibration damping characteristics and the frequency tuning of the dynamic damper 10, thereby stably obtaining the desired vibration damping performance.

Meanwhile, the flange-shaped protrusion 26 of the attachment fitting 14 is located below the mass member 16, and its radially outer end is located on the radially outer side of the radially inner end of the mass member 16. With this configuration, even if the connecting rubber elastic body 18 breaks and the mass member 16 falls with respect to the attachment fitting 14, the mass member 16 will be caught by the flange-shaped protrusion 26 of the attachment fitting 14, so as to constitute a fail-safe structure to prevent the mass member 16 from detaching from the attachment fitting 14. Therefore, with the dynamic damper 10 mounted on the vehicle, even if the connecting rubber elastic body 18 breaks, the mass member 16 can be prevented from falling to the road surface. Here, if the connecting rubber elastic body 18 breaks, upward separation of the mass member 16 is prevented by contact between the mass member 16 and the brace fitting 56, so that the separation of the mass member 16 is prevented on both the upper and lower sides.

A practical embodiment of the present disclosure has been described in detail above, but the present disclosure is not limited to those specific descriptions. For example, a tapered part is not essential in the circumferential wall of the attachment fitting, and the circumferential wall may extend straight with an approximately constant diameter across the entire axial length. Besides, the flange-shaped protrusion 26 of the circumferential wall may be omitted, or if the flange-shaped protrusion is provided, the flange-shaped protrusion need not constitute the fail-safe structure. Moreover, the stepped part is not essential in the base wall of the attachment fitting, and for example, the entire base wall may have a flat plate shape.

The thick-walled part of the mass body is not essential, and may have a constant thickness in its entirety in the radial direction. Additionally, depending on the shape of the brace fitting, the installation space for the dynamic damper, or the like, the radially outer portion of the mass body may be thick-walled. Furthermore, the thick-walled part of the mass body may protrude to the side opposite to the member mount to be thick.

It would be acceptable as long as the covering rubbers of the connecting rubber elastic body hold the radially inner portion of the mass body so as to cover from the axially opposite sides, and need not necessarily be provided to cover as far as the outer circumferential surface of the thick-walled part of the mass body. The connecting rubber elastic body may be fastened to the circumferential wall of the attachment fitting at a position away from the tapered part.

The axially opposite end surfaces of the connecting rubber elastic body may be located inside in the axial direction with respect to the axially opposite end surfaces of the thick-walled part of the mass member. Thus, the minimum axial dimension of the connecting rubber elastic body may be smaller than the axial dimension of the mass member in the thick-walled part.

What is claimed is:

1. A dynamic damper configured to be mounted onto a tubular member mount, the tubular member mount including an inner shaft member and an outer tube member connected by an elastic body, the dynamic damper comprising:
an attachment fitting including a tubular circumferential wall, the attachment fitting being arranged on one axial end side of the inner shaft member of the tubular member mount and fixed to the inner shaft member with the tubular circumferential wall extending in a center axis direction;
an annular mass body spaced radially outward from the tubular circumferential wall of the attachment fitting; and
a connecting rubber elastic body connecting opposed surfaces of the tubular circumferential wall and the annular mass body in an axis-perpendicular direction, wherein
a covering rubber is integrally formed with a radially outer portion of the connecting rubber elastic body, the covering rubber spreading over axially opposite end surfaces of the annular mass body and holding to cover a radially inner portion of the annular mass body from axially opposite sides, and
an axial dimension of the connecting rubber elastic body is smaller than that of the tubular circumferential wall.

2. The dynamic damper according to claim 1, wherein
axially opposite end surfaces of the connecting rubber elastic body between the opposed surfaces of the tubular circumferential wall and the annular mass body in the axis-perpendicular direction are located outside in an axial direction with respect to the axially opposite end surfaces of the radially inner portion of the annular mass body, and
axially opposite side portions of the connecting rubber elastic body extend radially outward to integrally form the covering rubber.

3. The dynamic damper according to claim 1, wherein the radially inner portion of the annular mass body includes a thick-walled part whose axial dimension is larger than that of a radially outer portion of the annular mass body.

4. The dynamic damper according to claim 3, wherein on an axial end surface of the annular mass body, the covering rubber spreads as far as a radially outer side of the thick-walled part and covers a radially outer end of the thick-walled part.

5. The dynamic damper according to claim 1, wherein the attachment fitting and the annular mass body are bonded by vulcanization to the connecting rubber elastic body.

6. The dynamic damper according to claim 1, wherein a radially outer end portion of the covering rubber includes a material casting trace during molding of the connecting rubber elastic body.

7. The dynamic damper according to claim 1, wherein
the attachment fitting includes a flange-shaped protrusion spreading radially outward from an axial end of the tubular circumferential wall, the axial end being located on an axially opposite side to the tubular member mount, and
a radially outer end of the flange-shaped protrusion is located on a radially outer side of a radially inner end of the annular mass body to constitute a fail-safe structure that prevents detachment of the annular mass body due to a break of the connecting rubber elastic body.

8. The dynamic damper according to claim 1, wherein
the tubular circumferential wall includes a tapered part on an other axial end located on a side of the tubular member mount, the tapered part gradually decreasing in diameter outward in an axial direction, and
the connecting rubber elastic body is fastened to an outer circumferential surface of the tapered part as well.

9. The dynamic damper according to claim 1, wherein
the attachment fitting includes a base wall having a flat plate shape and spreading radially inward from an other axial end of the tubular circumferential wall, the other axial end being located on a side of the tubular member mount, and
a radially outer portion of the base wall includes an annular stepped part, and a radially inner side of the annular stepped part comprises an attachment surface protruding in an axial direction.

10. The dynamic damper according to claim 9 configured to be mounted onto the tubular member mount including a brace fitting spreading in the axis-perpendicular direction at one axial end of the inner shaft member, the brace fitting including: an annular rising piece formed at a radially outer edge of the brace fitting, the annular rising piece being located on a radially outer side with respect to the covering rubber of the connecting rubber elastic body while extending in the axial direction toward the annular mass body; and an annular concave stepped part provided in a radially middle portion of an axially outer surface of the brace fitting such that a radially inner side of the annular concave stepped part comprises an attachment target surface recessed in the axial direction, wherein
the attachment surface of the attachment fitting is overlapped with the attachment target surface such that the annular stepped part of the attachment fitting is aligned with the annular concave stepped part in the axis-perpendicular direction.
